(19) United States
(12) Patent Application Publication
(10) Pub. No.: US 2013/0234644 A1
(43) Pub. Date: Sep. 12, 2013

(54) Rechargeable battery set integrated into pants belt

(71) Applicants: T. Shane Weeks, Paget (BM); Mstira Weeks, Paget (BM)

(72) Inventors: T. Shane Weeks, Paget (BM); Mstira Weeks, Paget (BM)

(21) Appl. No.: 13/385,834

(22) Filed: Mar. 9, 2012

(51) Int. Cl. H02J 7/00

(52) U.S. Cl. 320/101; 320/103

(57) ABSTRACT

A rechargeable battery set integrated into pants belt. The belt includes a front elongate belt strip member, a rear elongate belt strip member, a plurality of rechargeable batteries, a plurality of battery retaining cover plates, a belt buckle, a female mini jack, a voltage regulator circuit and a mini jack to smart phone connection cable. The mini jack to smart phone connection cable is capable of extending from the voltage regulator circuit at one end the female receptacle of a standard cell phone enabling the phone to be charged by the rechargeable batteries located within the pants belt.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of pants belts and more specifically to a rechargeable battery set integrated into pants belt.

Currently, many portable battery operated devices are available that need recharging when the batteries within the device loose power. Typically, a user will use a connecting cable to attach the portable device to a recharging station, which is usually powered by a standard AC power source such as a wall socket in a home or office. Recently, portable DC power sources have been made available for recharging a portable device such as a cell phone or electronic tablet while not in close proximity to an AC power source.

These portable DC power supplies usually are enclosed in a rigid housing that needs to be carried by the user in a pocket, purse, backpack or briefcase. However there are times when it would be preferable not to have to carry a bag or briefcase for the purpose of transporting a DC charging device. There are also time when it would be preferable not to carry a bulky charging device in ones pocket.

### BRIEF SUMMARY OF THE INVENTION

The primary object of the invention is to provide a rechargeable set of batteries that integrate into a flexible belt where the resulting belt has the appearance of a standard belt worn to support a person's pants.

Another object of the invention is to provide a rechargeable battery pants belt where a standard smart phone or other electronic device can be recharged by plugging a cord extending from the belt, into the recharging socket of the phone or other electronic device.

Another object of the invention is to provide a rechargeable battery pants belt that includes a retractable cord reel built into the buckle portion of the belt so that a phone or other portable device can be used by a person while the phone or other portable device is being charged.

A further object of the invention is to provide a rechargeable battery pants belt that is thin enough and flexible enough to operate as a standard pants belt.

Yet another object of the invention is to provide a rechargeable battery pants belt that allows the user to recharge a standard smart phone 10 times before the batteries in the belt need recharging.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a rechargeable battery set integrated into pants belt comprising: a front elongate belt strip member, a rear elongate belt strip member, a plurality of rechargeable batteries, a plurality of battery retaining cover plates, a belt buckle, a female mini jack, a mini jack to smart phone connection cable, a plurality of standard coated electrical wires, a battery regulator circuit, a battery regulator circuit housing, said mini jack to smart phone connection cable capable of extending from said regulator circuit, through one end of said regulator circuit housing and terminating in a standard cell phone input plug, said standard cell phone input plug capable of mating with the female receptacle of said standard cell phone enabling said standard cell phone to be charged by said rechargeable batteries located within said pants belt, said batteries covered by said battery retaining cover plates, said rear belt member including a plurality of cutouts that correspond to the perimeter shape of said batteries and said battery cover plates, said battery and said battery cover plate retained between said front belt member and said rear belt member, the rear side of said front belt member and the front side of said rear belt member fixedly attached to each other by standard means, said rechargeable batteries connected to each other by said coated electrical wires in a series configuration and said female mini jack fixedly retained between said front belt member and said rear belt member so that the orifice of said mini jack is exposed at the bottom edge of said front and rear belt members.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a perspective view of a second embodiment of the invention.

FIG. 3 is a top plan view of the invention with the rear belt strip removed.

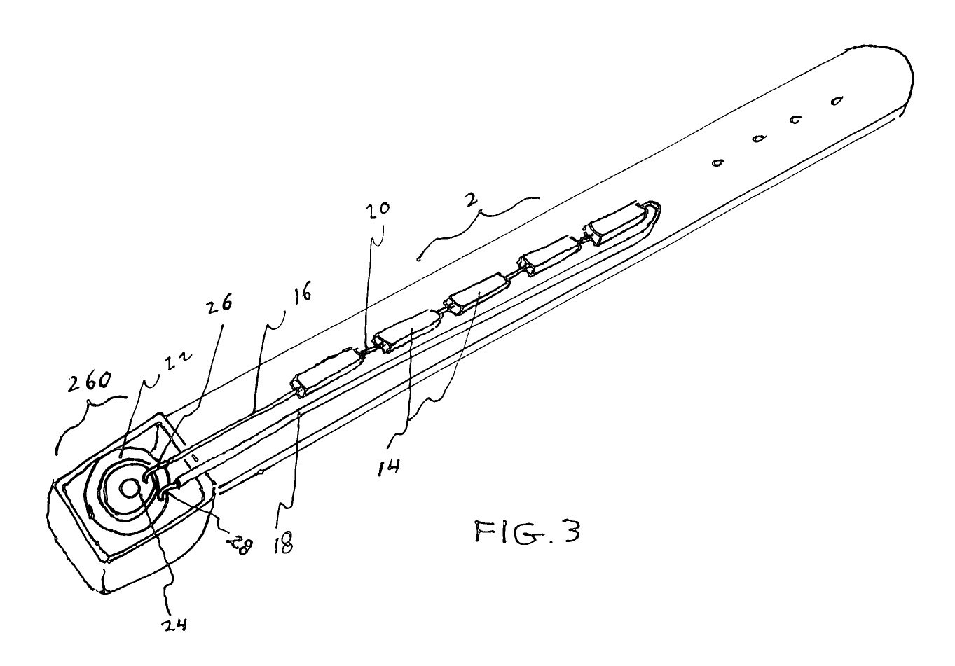

FIG. 4 is a perspective view of the invention being worn by a user.

FIG. 5 is a perspective view of the invention with the power cord extended.

FIG. 6 is an exploded view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

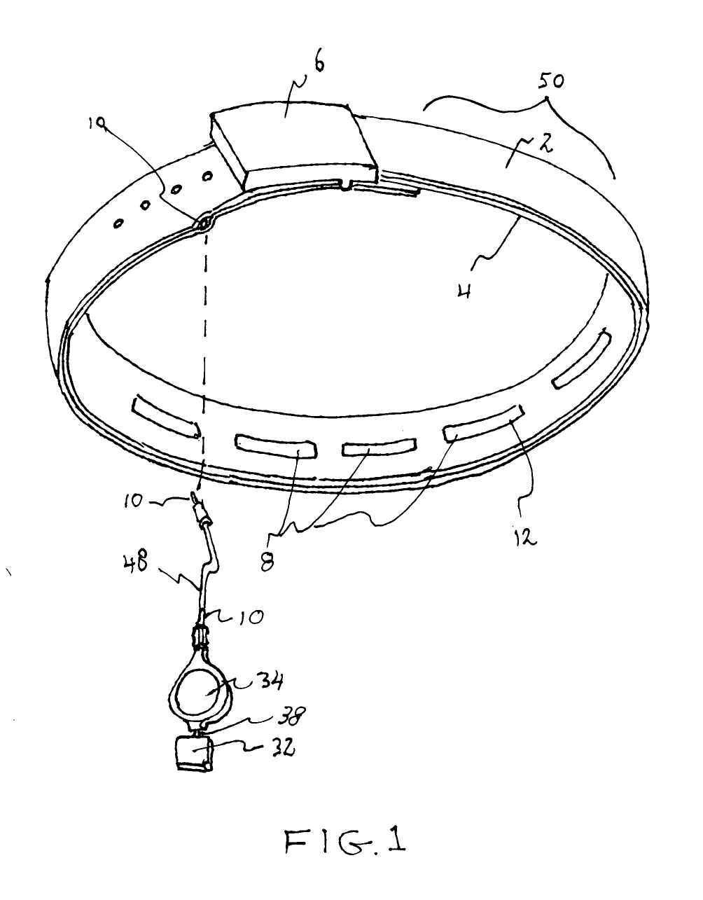

Referring now to FIG. 1 we see a perspective view of the invention looking up at a pants belt 50 that includes an outer flexible strip 2 and an inner flexible strip 4 and a buckle portion 6. The inner flexible strip 4 includes a plurality of cutout portions 12 allow battery cover members 8 to protrude through and be flush with the top surface of inner flexible strip 4. This configuration minimizes the overall thickness of the belt 50 so that it more closely resembles a standard pants belt. A female mini jack 10 is fixedly sandwiched between the inner belt strip 4 and outer belt strip 2. A retractable extension cable 38 and a voltage regulator circuit, not shown, is housed in a rigid hollow housing 34. Cable 38 terminates in a cell phone plug 32. Alternately, other plugs can be substituted for the phone plug depending on the electronic device to be charged such as an electronic tablet or a portable gaming device. Also, alternately, the attachment cable 38 and attached voltage regulator can be designed with out the inclusion of the extension cable 38 and its housing.

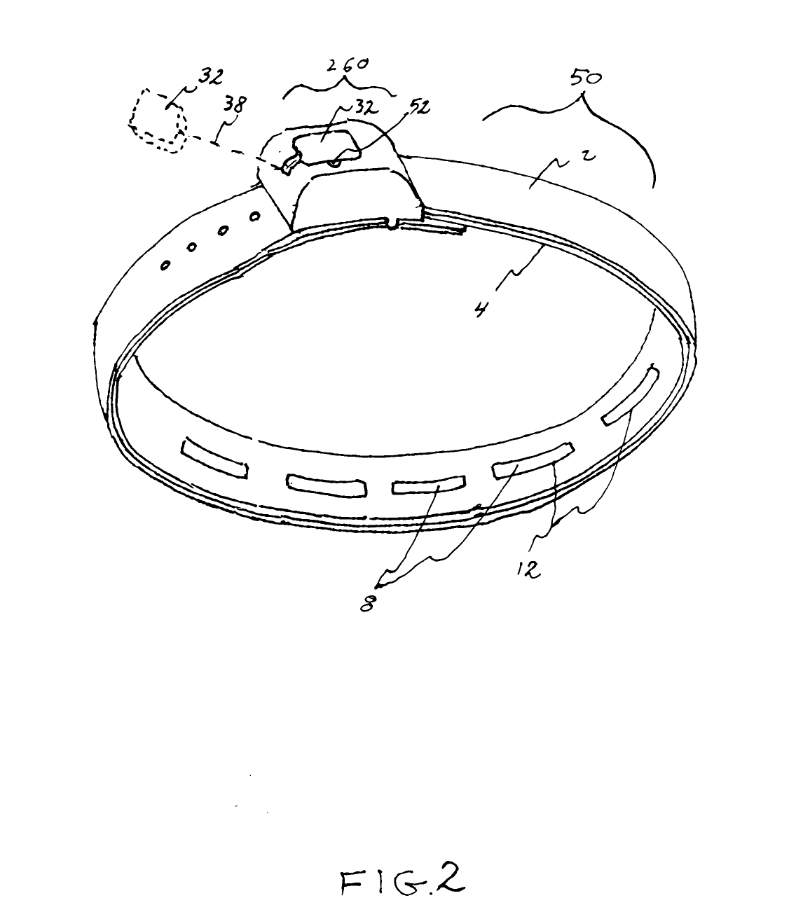

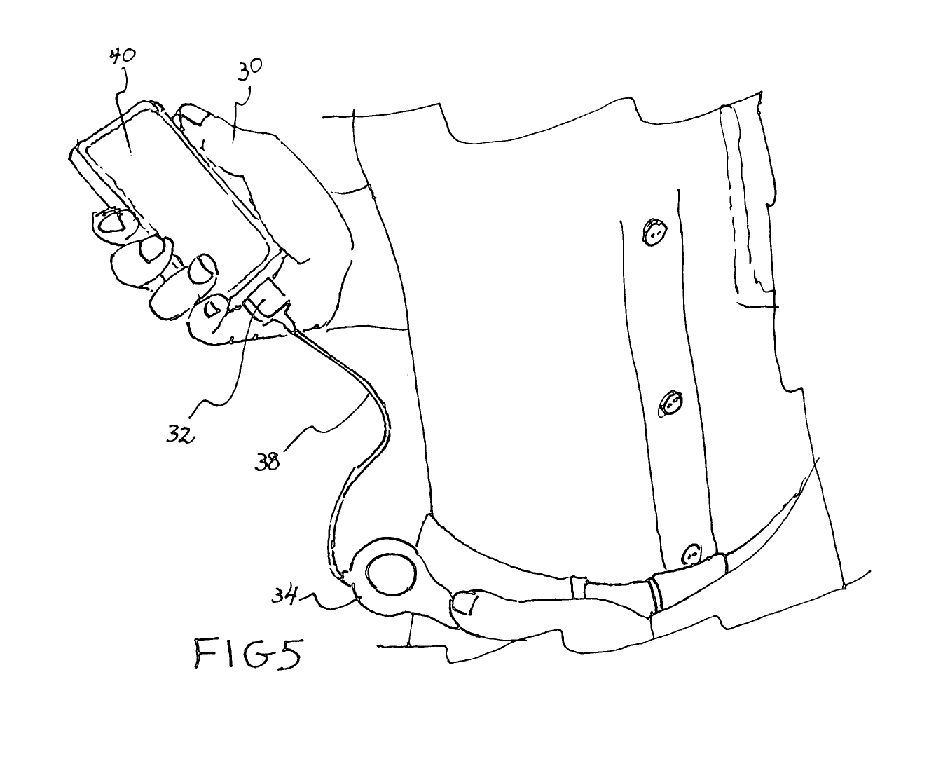

FIG. 2 shows a perspective view of an alternate embodiment to the invention 50 where the buckle portion 260 is hollow and contains within it a retractable cable shown by dotted line 38 and phone plug 32. This embodiment eliminates the need for a separate retractable cable assembly and housing 34 as shown in FIG. 1. A third embodiment, not shown, includes the use of a separate electrical cord 48 and phone plug 32 without the retractable cable 38 and cable housing 34. The extendible and retractable cable 38 allows the user to use a phone 40 or other electronic battery operated device while the phone 40 or other device is in the process of being charged by the present invention as shown in FIG. 5. A further alternate embodiment can include a flexible photovoltaic strip forming the outer belt strip 2, allowing the batteries 14 to be charged by the sun while the user is wearing the belt.

Figure the shows a perspective view of the outer belt strip 2 with the inner belt strip 4 removed. Five gum stick sized batteries 14 are attached to each other by coated wires 20 in a series circuit with final wires 16, 18 that terminate in wiping metal contacts 26, 28 that engage rotatable concentric ring contacts 22, 24. In this way, power is transferred from the batteries 14 to the extendable cable 38. The batteries 14 are rechargeable NiMi type that each have a rating of 1450 mAh and 1.2 volts. The five batteries 14 provide a total voltage of 5.8 volts. Since the standard cell phone requires 5.2 volts, the battery set 14 requires more than enough voltage to recharge a standard cell phone. The built in voltage regulator circuit limits outgoing voltage to the desired voltage depending on the electronic device being charged. Obviously, a variety of voltages could be accommodated within the design by adding a voltage selection switch and accompanying standard circuitry.

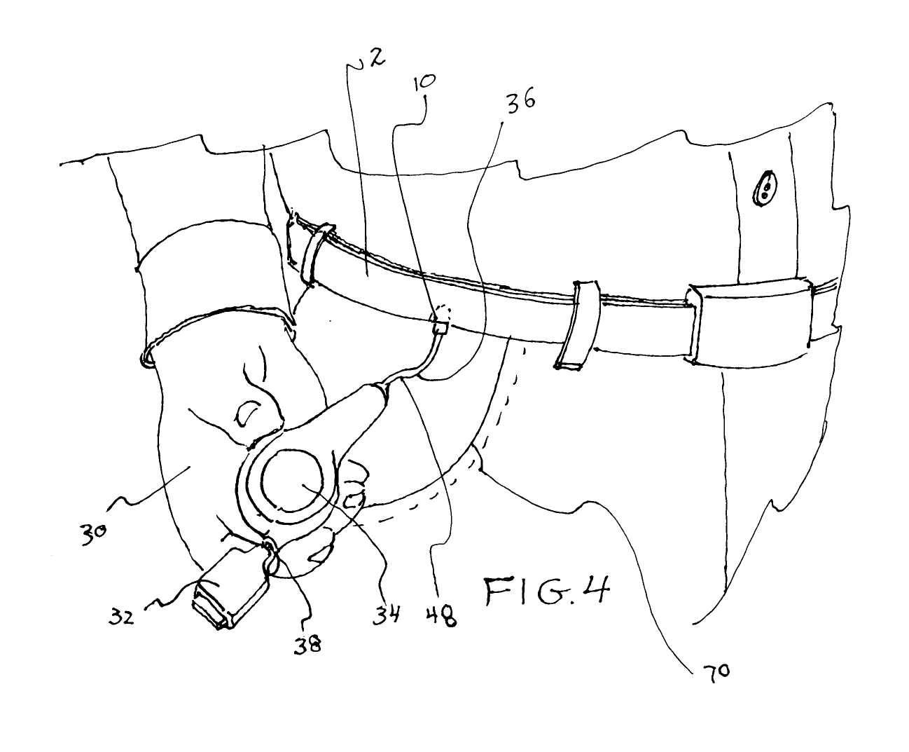

FIG. 4 shows a perspective view of a person 30 holding the hollow rigid housing 34 that contains the extendable power cord 38. This housing 34 and attached cord 48 and phone plug 32 is small enough in size that it can easily be stored in a person's pocket 70 along with an attached phone 40 as shown in FIG. 5. as attached cord 48 is plugged into female mini-jack 10 allowing the phone 40 to be charged while in the user's pocket 70.

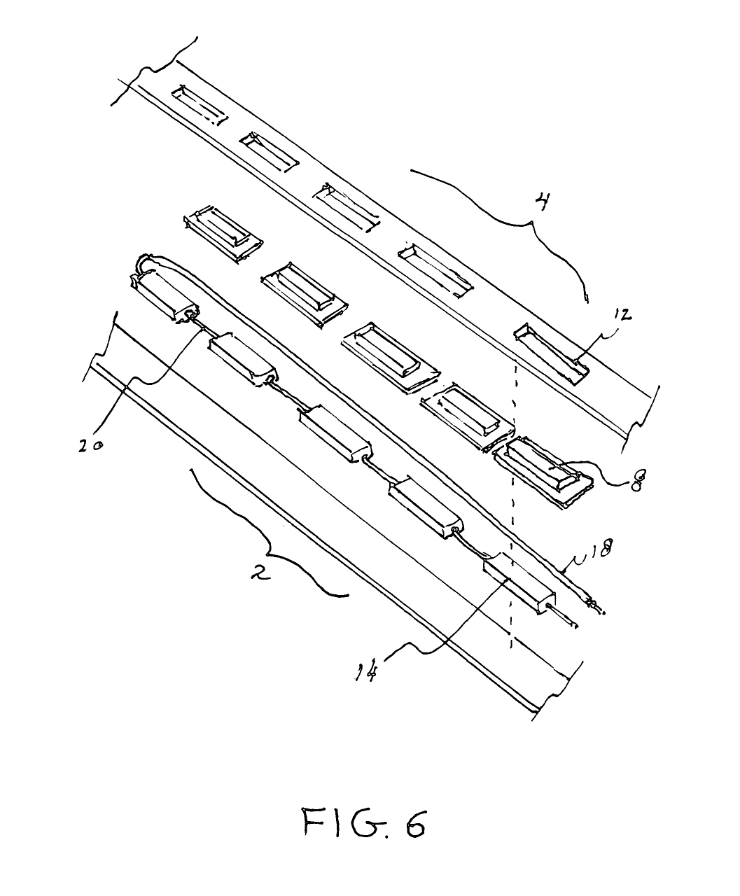

FIG. 6 shows a partial exploded view of the outer belt strip 2 and the inner belt strip 4 with batteries 14 and battery covers 8 clearly shown. During assembly, the batteries 14 are laid down on the inner surface of the outer belt strip 2. The battery cover members 8 are then placed over the batteries 14. The inner belt strip 4 is joined to the outer belt strip 2 by means of adhesive, or sewing, or both. The electrical wires 18, are also sandwiched between outer belt strip 2 and inner belt strip 4. The resulting belt assembly allows a person to recharge a portable electronic device without the need for carrying a separate charging device. The power of the enclosed batteries 14 allows a standard cell phone to be recharged up to ten times before the enclosed batteries 14 need to be recharged. The batteries 14 can be recharged by plugging a DC cable from a standard 120VAC charging device into mini-jack 10.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A rechargeable battery set integrated into pants belt comprising:
a front elongate belt strip member;
a rear elongate belt strip member;
a plurality of rechargeable batteries;
a plurality of battery retaining cover plates;
a belt buckle;
a female mini jack;
a mini jack to smart phone connection cable;
a plurality of standard coated electrical wires;
a battery regulator circuit;
a battery regulator circuit housing;
said mini jack to smart phone connection cable capable of extending from said regulator circuit, through one end of said regulator circuit housing and terminating in a standard cell phone input plug;
said standard cell phone input plug capable of mating with the female receptacle of said standard cell phone enabling said standard cell phone to be charged by said rechargeable batteries located within said pants belt;
said batteries covered by said battery retaining cover plates;
said rear belt member including a plurality of cutouts that correspond to the perimeter shape of said batteries and said battery cover plates;
said battery and said battery cover plate retained between said front belt member and said rear belt member;
the rear side of said front belt member and the front side of said rear belt member fixedly attached to each other by standard means;
said rechargeable batteries attached to each other by said coated electrical wires in a series configuration and
said female mini jack fixedly retained between said front belt member and said rear belt member so that the orifice of said mini jack is exposed at the bottom edge of said front and rear belt members.

2. An alternate embodiment of said battery set integrated into a pants belt as claimed in claim 1 wherein said retractable cable and cable housing is built into the front portion of the buckle of said belt.

3. An alternate embodiment of said battery set integrated into a pants belt as claimed in claim 1 wherein said front belt strip member is comprised of a flexible photovoltaic strip capable of recharging said batteries inside said pants belt.
